(19) United States
(12) Patent Application Publication
(10) Pub. No.: US 2017/0364200 A1
(43) Pub. Date: Dec. 21, 2017

(54) SYSTEM AND METHOD FOR CONVERTING CRT TOUCHSCREEN MONITOR TO FLAT TOUCHSCREEN MONITOR

(71) Applicant: Ampronix, Inc., Irvine, CA (US)

(72) Inventor: Nausser Fathollahi, Irvine, CA (US)

(21) Appl. No.: 15/625,267

(22) Filed: Jun. 16, 2017

Related U.S. Application Data
(60) Provisional application No. 62/352,060, filed on Jun. 20, 2016.

(51) Int. Cl. G06F 3/041; G06F 3/042

(52) U.S. Cl. CPC G06F 3/0416; G06F 3/0421

(57) ABSTRACT

A flat touchscreen monitor that uses touchscreen-effectuating components from a cathode ray tube (CRT) monitor to allow users to upgrade to a flat touchscreen monitor without having to purchase a new flat touchscreen monitor. The flat touchscreen monitor includes first, second, third, and fourth curved-array connectors that were previously configured to electrically attach to a pair of curved-array of IR transmitters and a pair of curved-array of IR receivers, respectively. The monitor further includes first and second straight-array of IR transmitters electrically coupled to the first and second curved-array of connectors, respectively. Additionally, the monitor includes first and second straight-array of IR receivers electrically coupled to the third and fourth curved-array of connectors, respectively. The third and fourth curved-array of connectors are electrically coupled to a touchscreen controller. The straight-array of IR transmitters and receivers may be positioned on all sides of a flatscreen to effectuate the touchscreen operation.

### CROSS-REFERENCE TO RELATED APPLICATION

This application claims the benefit of the filing date of U.S. Provisional Application, Ser. No. 62/352,060, filed on Jun. 20, 2016, which is incorporated herein by reference.

### FIELD

Aspects of the present disclosure relate generally to medical imaging systems, and more particularly, to a system, apparatus, and method for converting a cathode ray tube (CRT) touchscreen monitor used for medical imaging purposes to a flat touchscreen monitor for the same use.

### BACKGROUND

In the past, medical imaging monitors were configured as cathode ray tube (CRT) type monitors. For medical imaging applications, the CRT monitors were further configured to include a touchscreen to allow medical personnel, such as doctors, nurses, and others, to more easily interact with the touchscreen monitor while performing medical procedure on patients.

However, due to CRT monitors generally becoming obsolete and making way for flatscreen monitors, some medical facilities are discarding the old CRT touchscreen monitors for the new flatscreen touchscreen monitors. But this upgrade may be very expensive for medical facilities as they may have to replace many CRT touchscreen monitors with a corresponding number of flatscreen touchscreen monitors. For some medical facilities, the cost itself is an obstacle for achieving the desired upgrade.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

An aspect of the disclosure relates to a touchscreen monitor, comprising a touchscreen controller; a source for generating a drive voltage; a first curved-array of connectors each configured to receive the drive voltage; a first straight-array of infrared (IR) transmitters configured to: receive the drive voltage via the first curved-array of connectors, respectively, and generate IR signals in response to receiving the drive voltage; a second straight-array of IR receivers configured to generate electrical signals based on receiving the IR signals, respectively; and a second curved-array of connectors configured to receive the electrical signals for routing to the touchscreen controller, respectively.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the description embodiments are intended to include all such aspects and their equivalents.

### BRIEF DESCRIPTION OF THE DRAWINGS

FIG. 1A illustrates a front view of an exemplary medical imaging cathode ray tube (CRT) touchscreen monitor in accordance with an aspect of the disclosure.

FIG. 1B illustrates a block diagram of the exemplary medical imaging CRT touchscreen monitor in accordance with another aspect of the disclosure.

FIG. 2A illustrates a front view of an exemplary medical imaging converted-flat touchscreen monitor in accordance with another aspect of the disclosure.

FIG. 2B illustrates a block diagram of the exemplary medical imaging converted-flat touchscreen monitor in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

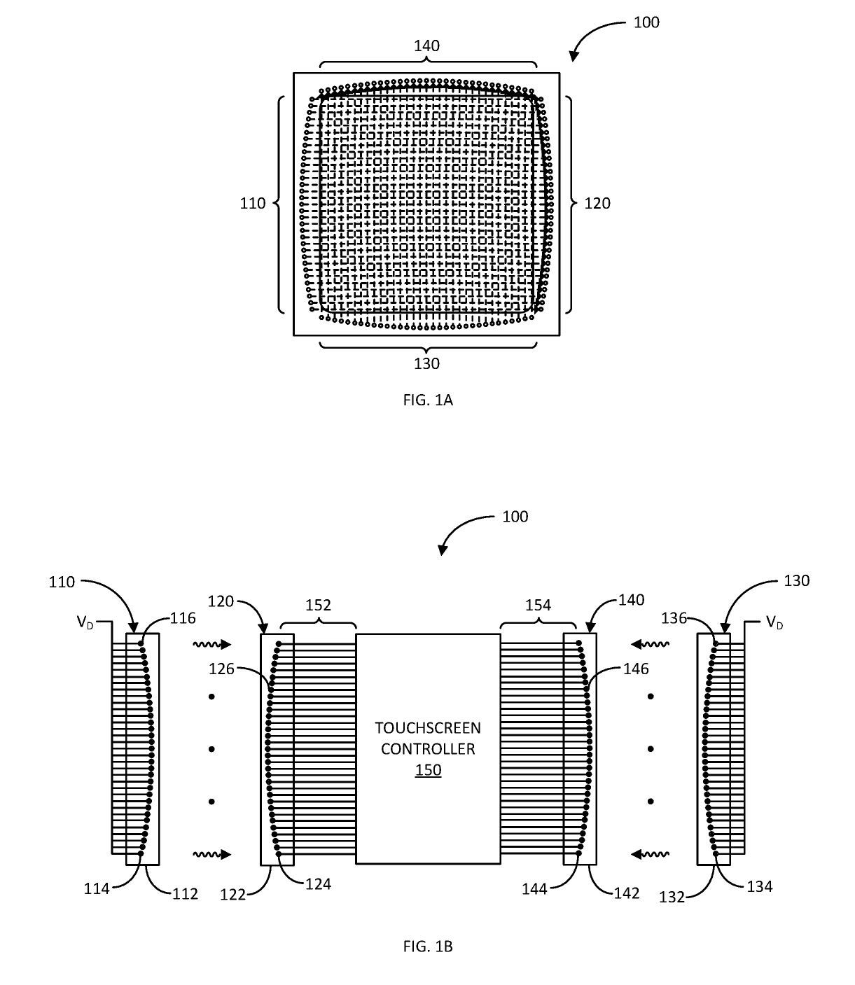

FIG. 1A illustrates a front view of an exemplary medical imaging cathode ray tube

(CRT) touchscreen monitor 100 in accordance with an aspect of the disclosure. As illustrated, the CRT touchscreen monitor 100 includes a touchscreen having an aspect ratio of substantially 1:1, as that is typical of CRT monitors.

The CRT touchscreen monitor 100 further includes components to effectuate the touchscreen operation of the monitor. For instance, the monitor 100 includes a first curved-array of infrared (IR) transmitters 110, a first curved-array of IR receivers 120, a second curved-array of IR transmitters 130, and a second curved-array of IR receivers 140.

The first curved-array of IR transmitters 110 is positioned along and substantially-aligned with the left-side of the touchscreen of the monitor 100, and oriented in a substantially-vertical manner with a symmetrical curved portion being concaved leftward and having an apex being substantially positioned at mid-height of the touchscreen. The first curved-array of IR transmitters 110 are configured to generate an array of horizontally-propagating IR signals extending substantially from the top to the bottom of the touchscreen, as indicated by the horizontal arrowed-lines.

The first curved-array of IR receivers 120 is positioned along and substantially-aligned with the right-side of the touchscreen of the monitor 100, and oriented in a substantially-vertical manner with a symmetrical curved portion being concaved rightward and having an apex being substantially positioned at mid-height of the touchscreen. If not occluded by a user's finger, the first curved-array of IR receivers 120 are configured to receive the array of horizontally-propagating IR signals generated by the first curved-array of IR transmitters 110, respectively.

Similarly, the second curved-array of IR transmitters 130 is positioned along and substantially-aligned with the bottom-side of the touchscreen of the monitor 100, and oriented in a substantially-horizontal manner with a symmetrical curved portion being concaved downward and having an apex being substantially positioned at mid-width of the touchscreen. The second curved-array of IR transmitters 130 are configured to generate an array of vertically-propagating IR signals extending substantially from the left-side to the right-side of the touchscreen, as indicated by the vertical arrowed-lines.

The second curved-array of IR receivers 140 is positioned along and substantially aligned with the top-side of the touchscreen of the monitor 100, and oriented in a substantially-horizontal manner with a symmetrical curved portion being concaved upward and having an apex being substantially positioned at mid-width of the touchscreen. If not occluded by a user's finger, the second curved-array of IR receivers 140 are configured to receive the array of vertically-propagating IR signals generated by the second curved-array of IR transmitters 130, respectively.

In operation, when a user's finger is placed on the touchscreen of the monitor 100, the finger blocks one or more of the horizontally- and vertically-propagating IR signals generated by the first and second curved-array of IR transmitters 110 and 130, respectively. As a consequence, a corresponding one or more IR receivers of the first and second curved-array of IR receivers 120 and 140 do not receive the IR signals blocked by the user's finger. A touchscreen controller (not shown in FIG. 1A) determines the position of the user's finger based on the IR receivers that do not receive the IR signals.

FIG. 1B illustrates a block diagram of the exemplary medical imaging CRT touchscreen monitor 100 in accordance with another aspect of the disclosure. As illustrated, the first curved-array of IR transmitters 110 includes a printed circuit board (PCB) 112 having thereon the individual IR transmitters 114 electrically attached to corresponding connectors 116 collectively oriented as a curved array as discussed. The IR transmitters 114 each receive a drive voltage V_{D} via metal traces disposed on the PCB 112 in order to generate the corresponding horizontally-propagating IR signal.

The first curved-array of IR receivers 120 includes a PCB 122 having thereon the individual IR receivers 124 electrically attached to corresponding connectors 126 collectively oriented as a curved array as discussed. The IR receivers 124 are coupled to a touchscreen controller 150 via a corresponding set of interconnects 152, respectively. The IR receivers 124 convert the received IR signals into electrical signals, which are sent to the touchscreen controller 150 via the set of interconnects 152, respectively.

Similarly, the second curved-array of IR transmitters 130 includes a PCB 132 having thereon the individual IR transmitters 134 electrically attached to corresponding connectors 136 collectively oriented as a curved array as discussed. The IR transmitters 134 each receive a drive voltage V_{D} via metal traces disposed on the PCB 132 in order to generate the corresponding vertically-propagating IR signal.

The second curved-array of IR receivers 140 includes a PCB 142 having thereon the individual IR receivers 144 electrically attached to corresponding connectors 146 collectively oriented as a curved array as discussed. The IR receivers 144 are coupled to the touchscreen controller 150 via a corresponding set of interconnects 154, respectively. The IR receivers 144 convert the received IR signals into electrical signals, which are sent to the touchscreen controller 150 via the set of interconnects 154, respectively.

As discussed, when a user's finger is placed on the touchscreen of the monitor 100, the finger blocks one or more of the horizontally- and vertically-propagating IR signals generated by the first and second curved-array of IR transmitters 110 and 130, respectively. As a consequence, a corresponding one or more IR receivers of the first and second curved-array of IR receivers 120 and 140 do not receive the IR signals blocked by the user's finger; and thus, the corresponding electrical signals are not sent to the touchscreen controller 150. Thus, the touchscreen controller 150 determines the position of the user's finger based on the IR receivers from which electrical signals are not received by the controller.

As CRT monitors are effectively obsolete and flatscreen monitors are more preferred, many medical personnel would rather use a flatscreen monitor than a CRT monitor. However, as there exists many CRT monitors for medical imaging purposes, the cost to medical facilities to replace the CRT monitors with flatscreen monitors could be very substantial. Accordingly, an alternative lower cost solution is needed to effectively replace the medical imaging CRT touchscreen monitor 100 with a medical imaging flat touchscreen monitor.

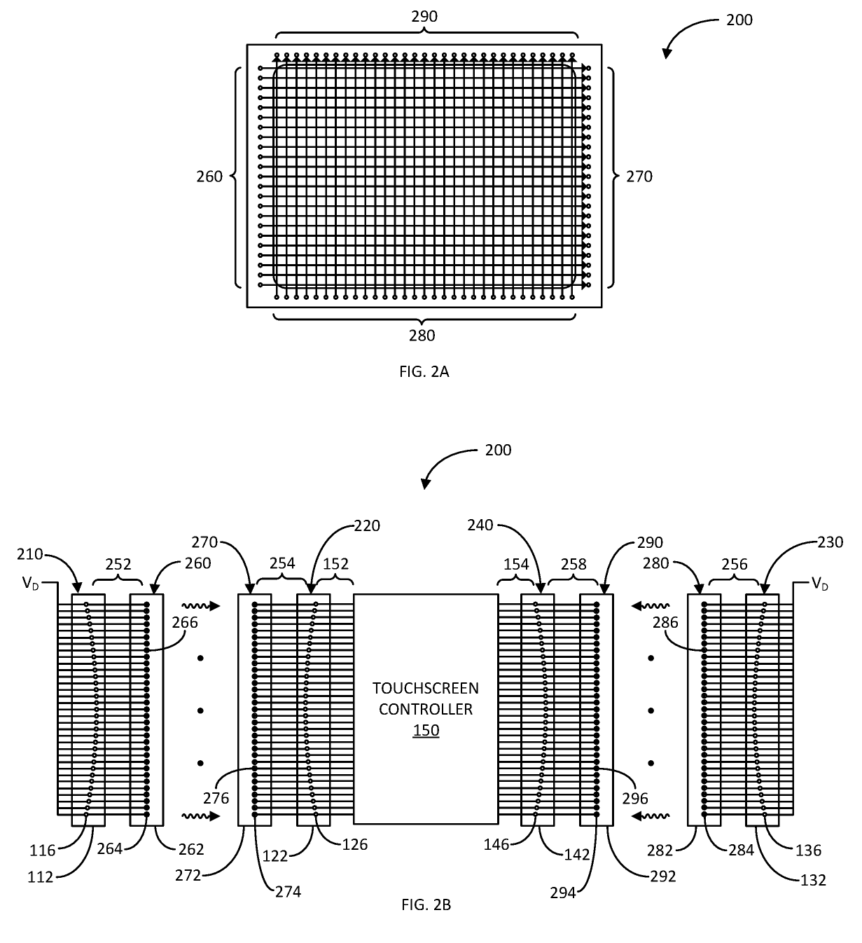

FIG. 2A illustrates a front view of an exemplary medical imaging converted-flat touchscreen monitor 200 in accordance with another aspect of the disclosure. As illustrated, the converted-flat touchscreen monitor 200 includes a touchscreen having an aspect ratio of substantially 4:3. However, it shall be understood that the converted-flat touchscreen monitor 200 may be configured to have any aspect ratio as desired.

The converted-flat touchscreen monitor 200 further includes components to effectuate the touchscreen operation of the monitor. For instance, the monitor 200 includes a first straight-array of IR transmitters 260, a first straight-array of IR receivers 270, a second straight-array of IR transmitters 280, and a second straight-array of IR receivers 290.

The first straight-array of IR transmitters 260 is positioned along and substantially aligned with the left-side of the touchscreen of the monitor 200, and oriented in a substantially-vertical manner The first straight-array of IR transmitters 260 are configured to generate an array of horizontally-propagating IR signals extending substantially from the top to the bottom of the touchscreen, as indicated by the horizontal arrowed-lines.

The first straight-array of IR receivers 270 is positioned along and substantially aligned with the right-side of the touchscreen of the monitor 200, and oriented in a substantially-vertical manner If not occluded by a user's finger, the first straight-array of IR receivers 270 are configured to receive the array of horizontally-propagating IR signals generated by the first straight-array of IR transmitters 260, respectively.

Similarly, the second straight-array of IR transmitters 280 is positioned along and substantially aligned with the bottom-side of the touchscreen of the monitor 200, and oriented in a substantially-horizontal manner The second straight-array of IR transmitters 280 are configured to generate an array of vertically-propagating IR signals extending substantially from the left-side to the right-side of the touchscreen, as indicated by the vertical arrowed-lines.

The second straight-array of IR receivers 290 is positioned along and substantially aligned with the top-side of the touchscreen of the monitor 200, and oriented in a substantially-horizontal manner If not occluded by a user's finger, the second straight-array of IR receivers 290 are configured to receive the array of vertically-propagating IR signals generated by the second straight-array of IR transmitters 280, respectively.

In operation, when a user's finger is placed on the touchscreen of the monitor 200, the finger blocks one or more of the horizontally- and vertically-propagating IR signals generated by the first and second straight-array of IR transmitters 260 and 280, respectively. As a consequence, a corresponding one or more IR receivers of the first and second curved-array of IR receivers 270 and 290 do not receive the IR signals blocked by the user's finger. A touchscreen controller (not shown in FIG. 2A) determines the position of the user's finger based on the IR receivers that do not receive the IR signals.

FIG. 2B illustrates a block diagram of the exemplary medical imaging converted-flat touchscreen monitor 200 in accordance with another aspect of the disclosure. In this example, the monitor 200 has been converted into a flat touchscreen monitor using some components from the CRT touchscreen monitor 100 previously discussed. For instance, the converted-flat touchscreen monitor 200 includes the same touchscreen controller 150 of the CRT touchscreen monitor 100. The converted-flat touchscreen monitor 200 includes modified components of the curved-array of transmitters 110/130 and receivers 120/140 of the CRT touchscreen monitor 100.

In particular, the converted-flat touchscreen monitor 200 includes a first drive voltage V_{D} source interconnect 210. The first drive voltage V_{D} source interconnect 210 is a modification to the first curved-array of IR transmitters 110 of CRT touchscreen monitor 100. That is, the drive voltage V_{D} source interconnect 210 includes the same PCB 112 and connectors 116 of the first curved-array of IR transmitters 110, but with the individual IR transmitters 114 removed from the connectors 116 and replaced with first ends of a set of interconnects 252, respectively.

The converted-flat touchscreen monitor 200 further comprises the first straight-array of IR transmitters 260 including a PCB 262 having thereon the individual IR transmitters 264 electrically attached to corresponding connectors 266 collectively oriented as a straight array as discussed. The IR transmitters 264 are coupled to second ends of the set of interconnects 252, respectively. Although, in this example, the set of interconnects 252 include an interconnect for each IR transmitter 264, it shall be understood that the PCB 262 may include a multiplexer, matrix, or other circuit to reduce the number of interconnects 252 to less than one interconnect per IR transmitter 264.

Accordingly, the IR transmitters 264 receive the drive voltage V_{D} from the drive voltage V_{D} source interconnect 210 via the set of interconnects 252, respectively. As in the previous embodiment, in response to the drive voltage V_{D}, the IR transmitters 264 generate the corresponding horizontally-propagating IR signals. Also, as the height of the monitor 200 may be different than the height of the monitor 100, the substantially uniform spacing between adjacent IR transmitters 264 may be different than the substantially uniform spacing between adjacent connectors 116 of the first drive voltage V_{D} source interconnect 210.

The converted-flat touchscreen monitor 200 also includes a first receiver interconnect 220. The first receiver interconnect 220 is a modification to the first curved-array of IR receivers 120 of CRT touchscreen monitor 100. That is, the first receiver interconnect 220 includes the same PCB 122 and connectors 126 as the first curved-array of IR receivers 120, but with the individual IR receivers 124 removed and replaced with first ends of a set of interconnects 254, respectively.

The converted-flat touchscreen monitor 200 further comprises the first straight-array of

IR receivers 270 including a PCB 272 having thereon the individual IR receivers 274 electrically attached to corresponding connectors 276 collectively oriented as a straight array as discussed. The IR receivers 274 are coupled to second ends of the set of interconnects 254, respectively. Although, in this example, the set of interconnects 254 include an interconnect for each IR receiver 274, it shall be understood that the PCB 272 may include a multiplexer, matrix, or other circuit to reduce the number of interconnects 254 to less than one interconnect per IR receiver 274. Also, as the height of the monitor 200 may be different than the height of the monitor 100, the substantially uniform spacing between adjacent IR receivers 274 may be different than the substantially uniform spacing between adjacent connectors 126 of the receiver interconnect 220.

If not occluded by a user's finger, the IR receivers 274 receive the horizontally-propagating IR signals generated by the first straight-array of IR transmitters 260, respectively. Accordingly, the IR receivers 274 convert the received IR signals into electrical signals, which are then sent to the touchscreen controller 150 via the set of interconnects 254, the first receiver interconnect 220, and the set of interconnects 152. The set of interconnects 152 are the same set of interconnects that couple the first curved-array of IR receivers 120 to the touchscreen controller 150.

Similarly, the converted-flat touchscreen monitor 200 includes a second drive voltage V_{D} source interconnect 230. The second drive voltage V_{D} source interconnect 230 is a modification to the second curved-array of IR transmitters 130 of CRT touchscreen monitor 100. That is, the second drive voltage V_{D} source interconnect 230 includes the same PCB 132 and connectors 136 as the second curved-array of IR transmitters 130, but with the individual IR transmitters 134 removed and replaced with first ends of a set of interconnects 256, respectively.

The converted-flat touchscreen monitor 200 further comprises the second straight-array of IR transmitters 280 including a PCB 282 having thereon the individual IR transmitters 284 electrically attached to corresponding connectors 286 collectively oriented as a straight array as discussed. The IR transmitters 284 are coupled to second ends of the set of interconnects 256, respectively. Although, in this example, the set of interconnects 256 include an interconnect for each IR transmitter 284, it shall be understood that the PCB 282 may include a multiplexer, matrix, or other circuit to reduce the number of interconnects 256 to less than one interconnect per IR transmitter 284.

Accordingly, the IR transmitters 284 receive the drive voltage V_{D} from the second drive voltage V_{D} source interconnect 230 via the set of interconnects 256, respectively. As in the previous embodiment, in response to the drive voltage V_{D}, the IR transmitters 284 generate the corresponding vertically-propagating IR signals. Also, as the width of the monitor 200 may be different than the width of the monitor 100, the substantially uniform spacing between adjacent IR transmitters 284 may be different than the substantially uniform spacing between adjacent connectors 136 of the second drive voltage V_{D} source interconnect 230.

The converted-flat touchscreen monitor 200 also includes a second receiver interconnect 240. The second receiver interconnect 240 is a modification of the second curved-array of IR receivers 140 of CRT touchscreen monitor 100. That is, the second receiver interconnect 240 includes the same PCB 142 and connectors 146 as the second curved-array of IR receivers 140, but with the individual IR receivers 144 removed and replaced with first ends of a set of interconnects 258, respectively.

The converted-flat touchscreen monitor 200 further comprises the second straight-array of IR receivers 290 including a PCB 292 having thereon the individual IR receivers 294 electrically attached to corresponding connectors 296 collectively oriented as a straight array as discussed. The IR receivers 294 are coupled to second ends of the set of interconnects 258, respectively. Although, in this example, the set of interconnects 258 include an interconnect for each IR receiver 294, it shall be understood that the PCB 292 may include a multiplexer, matrix, or other circuit to reduce the number of interconnects 258 to less than one interconnect per IR receiver 294. Also, as the width of the monitor 200 may be different than the width of the monitor 100, the substantially uniform spacing between adjacent IR receivers 294 may be different than the spacing between adjacent connectors 146 of the receiver interconnect 240.

If not occluded by a user's finger, the IR receivers 294 receive the vertically-propagating IR signals generated by the second straight-array of IR transmitters 280, respectively. Accordingly, the IR receivers 294 convert the received IR signals into electrical signals, which are sent to the touchscreen controller 150 via the set of interconnects 258, the second receiver interconnect 240, and the set of interconnects 154. The set of interconnects 154 are the same set of interconnects that couple the second curved-array of IR receivers 140 to the touchscreen controller 150.

As discussed, when a user's fingers is placed on the touchscreen of the monitor 200, the finger blocks one or more of the horizontally- and vertically-propagating IR signals generated by the first and second straight-array of IR transmitters 260 and 280, respectively. As a consequence, a corresponding one or more IR receivers of the first and second straight-array of IR receivers 270 and 290 do not receive the IR signals blocked by the user's finger; and thus, the corresponding electrical signals are not sent to the touchscreen controller 150. Accordingly, the touchscreen controller 150 does not receive the corresponding electrical signals from the IR receivers associated with the blocked IR signals. Therefore, the touchscreen controller 150 determines the position of the user's finger based on the IR receivers from which electrical signals are not received by the controller.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus, comprising:
a touchscreen controller;
a source for generating a drive voltage;
a first curved-array of connectors each configured to receive the drive voltage;
a first straight-array of infrared (IR) transmitters configured to:
receive the drive voltage via the first curved-array of connectors, respectively; and
generate a first set of IR signals in response to the drive voltage;
a first straight-array of IR receivers configured to generate a first set of electrical signals based on the first set of IR signals, respectively; and
a second curved-array of connectors configured to receive the first set of electrical signals for routing to the touchscreen controller, respectively.

2. The apparatus of claim 1, wherein the connectors of the first or second curved-array are substantially uniformly spaced apart from each other.

3. The apparatus of claim 2, wherein the IR transmitters or IR receivers of the first straight-array are substantially uniformly spaced apart from each other.

4. The apparatus of claim 3, wherein a distance between adjacent IR transmitters or IR receivers is different than a distance between adjacent connectors.

5. The apparatus of claim 1, wherein the connectors of the first or second curved-array are configured to electrically attach to IR transmitters or IR receivers, respectively.

6. The apparatus of claim 1, further comprising a first or a second set of interconnects electrically connecting the connectors of the first or second curved-array to the IR transmitters or IR receivers, respectively.

7. The apparatus of claim 1, further comprising a first or a second straight-array of connectors, wherein the first straight-array of IR transmitters are electrically attached to the first set of straight-array of connectors, respectively, or wherein the first straight-array of IR receivers are electrically attached to the second straight-array of connectors, respectively.

8. The apparatus of claim 1, further comprising a first or a second set of interconnects for electrically coupling the first straight-array of IR receivers to the touchscreen controller.

9. The apparatus of claim 1, further comprising:
a third curved-array of connectors each configured to receive the drive voltage;
a second straight-array of infrared (IR) transmitters configured to:
receive the drive voltage via the third curved-array of connectors, respectively; and
generate a second set of IR signals in response to the drive voltage;
a second straight-array of IR receivers configured to generate a second set of electrical signals based on the second set of IR signals, respectively; and
a fourth curved-array of connectors configured to receive the second set of electrical signals for routing to the touchscreen controller, respectively.

10. The apparatus of claim 9, further comprising a screen.

11. The apparatus of claim 10,
wherein the first straight-array of IR transmitters are oriented substantially vertical along a first side of the screen and configured to generate substantially horizontally-propagating IR signals towards a second side of the screen;
wherein the first straight-array of IR receivers are oriented substantially vertical along the second side of the screen and configured to receive the substantially horizontally-propagating IR signals, respectively;
wherein the second straight-array of IR transmitters are oriented substantially horizontal along a third side of the screen and configured to generate substantially vertically-propagating IR signals towards a fourth side of the screen; and
wherein the second straight-array of IR receivers are oriented substantially horizontal along the fourth side of the screen and configured to receive the substantially vertically-propagating IR signals, respectively.

12. The apparatus of claim 11, wherein the touchscreen controller is configured to determine a location of an object touching the screen based on the first and second sets of electrical signals.

13. A flat touchscreen monitor, comprising:
a flatscreen;
a touchscreen controller;
a source for generating a drive voltage;
a first curved-array of connectors disposed on a first printed circuit board (PCB), wherein each of the connectors of the first curved-array is configured to receive the drive voltage;
a first straight-array of infrared (IR) transmitters attached to a first straight-array of connectors disposed on a second PCB, wherein the first straight-array of IR transmitters are situated substantially vertical along a first side of the flatscreen, and configured to:
receive the drive voltage via the first curved-array of connectors, respectively; and
generate a set of horizontally-propagating IR signals in response to the drive voltage;
a first straight-array of IR receivers attached to a second straight-array of connectors disposed on a third PCB, wherein the first straight-array of IR receivers are situated substantially vertical along a second side of the flatscreen, and configured to:
receive the first set of horizontally-propagating IR signals; and
generate a first set of electrical signals based on the set of horizontally-propagating IR signals, respectively; and
a second curved-array of connectors disposed on a fourth PCB, and configured to receive the first set of electrical signals for routing to the touchscreen controller, respectively;
a third curved-array of connectors disposed on a fifth PCB, wherein each of the connectors of the third curved-array is configured to receive the drive voltage;
a second straight-array of infrared (IR) transmitters attached to a third straight-array of connectors disposed on a sixth PCB, wherein the second straight-array of IR transmitters are situated substantially horizontal along a third side of the flatscreen, and configured to:
receive the drive voltage via the third curved-array of connectors, respectively; and
generate a set of vertically-propagating IR signals in response to the drive voltage;
a second straight-array of IR receivers attached to a fourth straight-array of connectors disposed on a seventh PCB, wherein the second straight-array of IR receivers are situated substantially horizontal along a fourth side of the flatscreen, and configured to:
receive the set of vertically-propagating IR signals; and
generate a second set of electrical signals based on the set of vertically-propagating IR signals, respectively; and
a fourth curved-array of connectors disposed on an eight PCB, and configured to receive the second set of electrical signals for routing to the touchscreen controller, respectively;
wherein the touchscreen controller is configured to determine an object touching the flatscreen based on the first and second sets of electrical signals.

14. The flat touchscreen monitor of claim 13,
wherein the first and third curved-array of connectors were previously configured to electrically attach to first and second curved-array of IR transmitters for a cathode ray tube (CRT) monitor; and
wherein the second and fourth curved-array of connectors were previously configured to electrically attach to first and second curved-array of IR receivers for the CRT monitor.

15. The flat touchscreen monitor of claim 13, further comprising:
a first set of interconnects electrically connecting the first curved-array of connectors to the first straight-array of connectors, respectively;
a second set of interconnects electrically connecting the second curved-array of connectors to the second straight-array of connectors, respectively;
a third set of interconnects electrically connecting the third curved-array of connectors to the third straight-array of connectors, respectively; and
a fourth set of interconnects electrically connecting the fourth curved-array of connectors to the fourth straight-array of connectors.

16. The flat touch screen monitor of claim 15, further comprising:
a fifth set of interconnects electrically connecting the second curved-array of connectors to the touchscreen controller, respectively;
a sixth set of interconnects electrically connecting the fourth curved-array of connectors to the touchscreen, respectively.

17. The flat touchscreen monitor of claim 13, wherein the flatscreen has an aspect ratio of substantially 4:3.
